(19) United States
(12) Patent Application Publication
(10) Pub. No.: US 2023/0070983 A1
(43) Pub. Date: Mar. 9, 2023

(54) ANODE CURRENT COLLECTOR INCLUDING POROUS PLATING LAYER, AND ANODE FOR LITHIUM SECONDARY BATTERY INCLUDING SAME

(71) Applicants: Hyundai Motor Company, Seoul (KR); Kia Corporation, Seoul (KR); SEOUL NATIONAL UNIVERSITY R&DB FOUNDATION, Seoul (KR)

(72) Inventors: Jong Chan Song, Uiwang, Gyeonggi-do (KR); Jae Wook Shin, Uiwang, Gyeonggi-do (KR); Seong Min Ha, Uiwang, Gyeonggi-do (KR); Seung Jong Lee, Uiwang, Gyeonggi-do (KR); Won Keun Kim, Uiwang, Gyeonggi-do (KR); Kyoung Han Ryu, Uiwang, Gyeonggi-do (KR); Yun Seog Lee, Seoul (KR); Ho Young Kim, Seoul (KR); Hee Dong Kwak, Gangwon-do (KR); Jung Taek Kim, Seoul (KR); Seung Eun Paik, Seoul (KR); Chang Hyun Lim, Seoul (KR)

(21) Appl. No.: 17/898,661

(22) Filed: Aug. 30, 2022

(30) Foreign Application Priority Data
Aug. 31, 2021 (KR) 10-2021-0115412

(51) Int. Cl. H01M 4/66; H01M 4/134; H01M 4/1395; H01M 4/80; H01M 10/0525

(52) U.S. Cl. CPC H01M 4/667; H01M 4/134; H01M 4/1395; H01M 4/661; H01M 4/80; H01M 10/0525; H01M 2004/021

(57) ABSTRACT

Disclosed are an anode for a lithium secondary battery including a porous and thin-film anode current collector layer and a method for manufacturing the same.

### CROSS REFERENCE TO RELATED APPLICATION

The present application claims priority to Korean Patent Application No. 10-2021-0115412, filed Aug. 31, 2021, the entire contents of which is incorporated herein for all purposes by this reference.

### TECHNICAL HELD

The present invention relates to an anode including a porous thin-film anode current collector layer for a lithium secondary battery and a method for manufacturing the same.

### BACKGROUND

Lithium-ion secondary batteries have been used as main energy storage devices for portable devices, electric vehicles and the like. A lithium secondary battery includes a cathode, an anode, an electrolyte, a separator, and the like. In general, the cathode includes a transition metal oxide, and the anode includes a carbon material capable of reversibly intercalating and releasing lithium.

When the anode material is replaced with lithium metal in terms of energy density, the battery capacity may be increased, but lithium dendrite may be generated, and thus, charging and discharging efficiency may be degraded.

Therefore, there has been an attempt to suppress the growth of lithium dendrites by introducing a functional group into copper foam or performing heat treatment to increase wetting of lithium metal and then using the same as an anode current collector. However, the above copper foam has very thick with a thickness of 100 μm or greater, so the improvement of the energy density may be insignificant, and there is a limitation in that use thereof is not practical.

### SUMMARY OF THE INVENTION

In preferred aspects, provided are an anode current collector capable of suppressing the growth of lithium dendrites while significantly increasing the energy density of a lithium secondary battery, and a method for manufacturing the same.

The objective of the present invention is not limited to the object mentioned above. The objectives of the present invention will become more apparent from the following description and will be realized by means and combinations thereof recited in the claims.

In an aspect, provided is an anode for a lithium secondary battery may include an anode current collector layer including a substrate layer and a porous plating layer located on the substrate layer, and a lithium metal layer located on the plating layer. The anode current collector layer may have a thickness of about 5 μm to 50 μm.

The “porous layer” or “porous plating layer” as used herein refers to a layer or a film that includes plurality of shapes of pores (e.g., circular, or non-circular), holes, cavity (e.g., microcavity), labyrinth, channel or combinations thereof, whether formed uniformly or without regularity. Exemplary porous substrate may include pores (e.g., closed or open pores) within a predetermined size within a range from sub-micrometer to micrometer size, which is measured by maximum diameter of the pores.

The anode current collector layer may include copper, nickel, or combinations thereof.

The plating layer may include a first pore recessed into a predetermined depth from a surface thereof and a second pore formed therein.

The diameter of the first pore may be about 10 μm to 60 μm.

The anode may further include a coating layer formed on the plating layer to a thickness of about 10 nm to 100 nm.

The coating layer may include one or more selected from the group consisting of silver, gold, magnesium, silicon, zinc, germanium, tin, aluminum oxide, copper oxide, and zinc oxide.

The lithium metal layer may penetrate into the porous plating layer.

In another aspect, provided is a lithium secondary battery may include a cathode, the anode as described herein, a separator interposed between the cathode and the anode, and an electrolyte impregnated in the separator.

In an aspect, provided is a method of manufacturing an anode for a lithium secondary battery that may include: forming a porous plating layer on a substrate layer; preparing an anode current collector layer by forming a coating layer on the porous plating layer; and forming a lithium metal layer on the anode current collector layer.

Forming the plating layer may include immersing the substrate layer in a plating solution including a copper ion source and sulfuric acid and applying an electric current to the substrate layer to form a porous plating layer containing copper on the substrate layer.

A plating layer may be formed by applying a current having a current density of about 0.1 mA/cm² to 1 mA/cm² to the substrate layer for about 10 to 60 seconds.

A first pore formed to be recessed into a predetermined depth from a surface thereof, and a second pore positioned therein may be formed in the plating layer by hydrogen gas generated when a current is applied to the substrate layer.

The manufacturing method may further include, after forming the porous plating layer on the substrate, immersing the substrate layer on which the plating layer is formed in a plating solution including a copper ion source and sulfuric acid and applying an electric current to perform a post-plating treatment.

The coating layer may be formed by sputtering on the plating layer one or more metal selected from the group consisting of silver, gold, magnesium, silicon, zinc, germanium, tin, aluminum oxide, copper oxide, and zinc oxide.

The thickness of the coating layer may be about 10 nm to 100 nm.

The lithium metal layer may be formed by vapor permeating molten lithium on the plating layer.

In further aspects, provided is a vehicle that includes the lithium secondary battery as described herein.

According to the present invention, since the anode current collector can be thin-filmed, the energy density of the lithium secondary battery can be greatly increased.

According to various exemplary embodiments of the present invention, since a porous anode current collector can be obtained, the growth of lithium dendrites generated during the charging and discharging of a lithium secondary battery can be suppressed.

The effects of the present invention are not limited to the above-mentioned effects. It should be understood that the effects of the present invention include all effects that can be inferred from the following description.

### BRIEF DESCRIPTION OF THE DRAWINGS

FIG. 1 shows an exemplary lithium secondary battery according to an exemplary embodiment of the present invention;

FIG. 2 shows an enlarged view of a portion of an exemplary anode current collector layer according to an exemplary embodiment of the present invention;

FIG. 3 shows the result of forming an exemplary plating layer of the anode current collector layer according to an exemplary embodiment of the present invention;

FIG. 4 shows an exemplary explaining the process of forming pores in the plating layer according to an exemplary embodiment of the present invention;

FIG. 5 shows an exemplary plating layer after the post-plating according to an exemplary embodiment of the present invention;

FIG. 6 shows a result of forming an exemplary coating layer according to an exemplary embodiment of the present invention;

FIG. 7 shows an exemplary resultant lithium metal layer formed according to an exemplary embodiment of the present invention;

FIG. 8A shows a result of analyzing the surface of an exemplary plating layer with an electron microscope according to an exemplary embodiment of the present invention;

FIG. 8B shows a result of visually observing the surface of the plating layer according to an exemplary embodiment of the present invention;

FIG. 9 shows a result of visually observing the surface of an exemplary anode current collector layer according to an exemplary embodiment of the present invention;

FIG. 10 shows a result of visually observing the surface of an exemplary anode according to an exemplary embodiment of the present invention;

FIG. 11 shows a result of observing the behavior of symmetric cells according to Example, Comparative Example 1, and Comparative Example 2 while charging and discharging;

FIG. 12A shows a result of microscopic analysis of the surface of an exemplary anode current collector before electrodeposition according to an exemplary embodiment of the present invention;

FIG. 12B shows a result of microscopic analysis of the surface of an exemplary anode current collector after electrodeposition according to an exemplary embodiment of the present invention;

FIG. 13A shows a result of microscopic analysis of the surface of a copper thin film according to Comparative Example 2 before electrodeposition;

FIG. 13B shows a result of microscopic analysis of the surface of the copper thin film according to Comparative Example 2 after electrodeposition; and

FIG. 14 shows a graph of a voltage applied during lithium electrodeposition in Example and Comparative Example 2.

### DETAILED DESCRIPTION

The above objectives, other objectives, features, and advantages of the present invention will be easily understood through the following preferred embodiments in conjunction with the accompanying drawings. However, the present invention is not limited to the embodiments described herein and may be embodied in other forms. Rather, the embodiments introduced herein are provided so that the disclosed content may be thorough and complete, and the spirit of the present invention may be sufficiently conveyed to those skilled in the art.

In describing each figure, like reference numerals have been used for like elements. In the accompanying drawings, the dimensions of the structures are enlarged than actual for clarity of the present invention. Terms such as first, second, etc., may be used to describe various elements, but the elements should not be limited by the terms. The above terms are used only for the purpose of distinguishing one component from another. For example, without departing from the scope of the present invention, a first component may be referred to as a second component, and similarly, a second component may also be referred to as a first component. The singular expression includes the plural expression unless the context clearly dictates otherwise.

In this specification, it should be understood that the term “including” or “have” is intended to specify that features, numbers, steps, operations, components, parts, or a combination of them are described in the specification and does not preclude the presence or addition of one or more other features, numbers, steps, operations, elements, or combinations thereof. In addition, when a part such as a layer, film, region, plate, etc., is said to be “on” another part, this includes not only “directly above” the other part, but also the case where there is another part in the middle. Conversely, when a part such as a layer, film, region, plate, etc. is said to be “directly below” the other part, this includes not only the case where the other part is “directly below” but also the case where there is another part between them.

Unless otherwise specified, all numbers, values, and/or expressions expressing quantities of ingredients, reaction conditions, polymer compositions, and formulations used herein contain all numbers, values and/or expressions in which such numbers essentially occur in obtaining such values, among others. Since they are approximations reflecting various uncertainties in the measurement, it should be understood as being modified by the term “about” in all cases.

Further, unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

In addition, when the numerical range is disclosed in the present invention, this range is continuous and includes all values from the minimum value to the maximum, including the maximum value unless otherwise indicated. Furthermore, when this range refers to an integer, all integers, including the minimum value to the maximum value including the maximum value, are included unless otherwise pointed out. In the present specification, when a range is described for a variable, it will be understood that the variable includes all values including the end points described within the stated range. For example, the range of “5 to 10” will be understood to include any subranges, such as 6 to 10, 7 to 10, 6 to 9, 7 to 9, and the like, as well as individual values of 5, 6, 7, 8, 9 and 10, and will also be understood to include any value between valid integers within the stated range, such as 5.5, 6.5, 7.5, 5.5 to 8.5, 6.5 to 9, and the like. Also, for example, the range of “10% to 30%” will be understood to include subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 15.5%, 25.5%, and the like.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

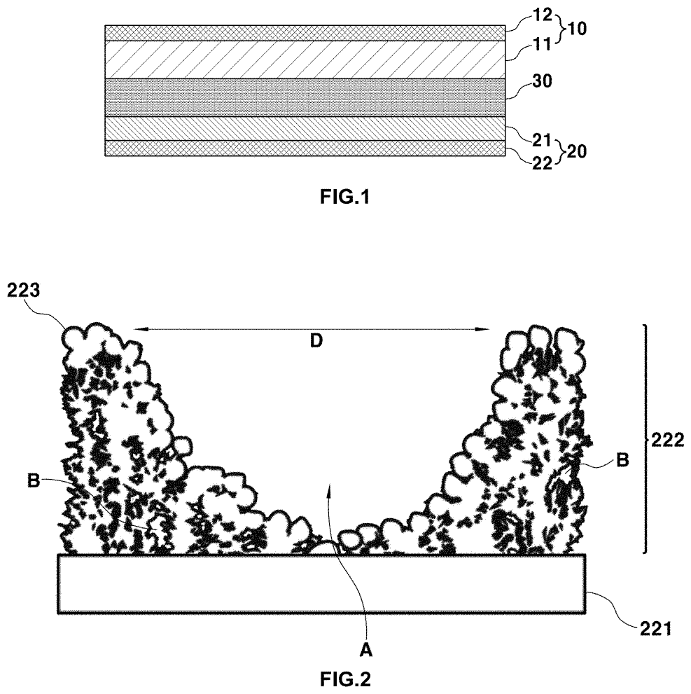

FIG. 1 shows an exemplary lithium secondary battery according to an exemplary embodiment of the present invention. For example, the lithium secondary battery may include a cathode 10, an anode 20, and a separator 30 interposed between the cathode 10 and the anode 20.

The cathode 10 may include a cathode active material layer 11 and a cathode current collector layer 12 positioned on the positive electrode active material layer.

The cathode active material layer 11 may include a cathode active material, a binder, a conductive material, and the like.

The cathode active material may include one or more selected from the group consisting of lithium cobalt oxide, lithium nickel cobalt manganese oxide, lithium nickel cobalt aluminum oxide, lithium iron phosphate oxide, lithium manganese oxide, and combinations thereof. However, the cathode active material is not limited thereto, and any cathode active material available in the art may be used.

The binder may assist in bonding the cathode electrode active material and the conductive agent and bonding to the current collector and may include one or more of polyvinylidene fluoride, polyvinyl alcohol, carboxymethyl cellulose (CMC), starch, hydroxypropyl cellulose, regenerated cellulose, polyvinylpyrrolidone, tetrafluoroethylene, polyethylene, polypropylene, ethylene-propylene-diene terpolymer (EPDM), sulfonated EPDM, styrene-butadiene rubber, fluoro rubber, various copolymers, and the like.

The conductive agent is not particularly limited as long as it has conductivity without causing a chemical change in the battery. For example, graphite such as natural graphite or artificial graphite; carbon-based materials such as carbon black, acetylene black, Ketjen black, channel black, furnace black, lamp black, and summer black; conductive fibers such as carbon fiber and metal fiber; metal powders such as carbon fluoride, aluminum, and nickel powder; conductive whiskers such as zinc oxide and potassium titanate; conductive metal oxides such as titanium oxide; and conductive materials such as polyphenylene derivatives may be included.

The cathode current collector layer 12 may be an electrically conductive plate-shaped substrate. The cathode current collector layer 12 may include an aluminum foil.

The anode 20 may include an anode current collector layer 22 and a lithium metal layer 21 on the anode current collector layer 22.

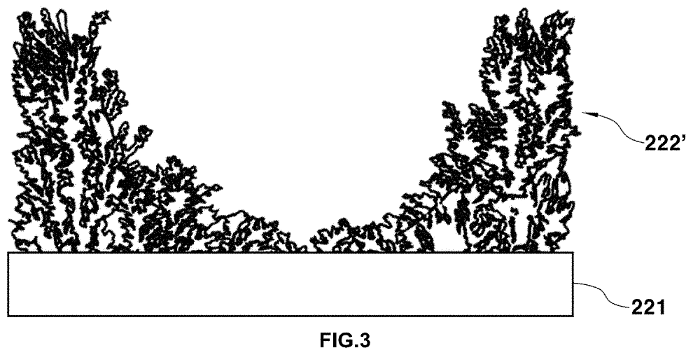

FIG. 2 shows an enlarged view of a portion of an exemplary anode current collector layer 22. FIG. 2 is provided to aid understanding of the present invention, however, the shape of the anode current collector layer 22 is not limited thereto.

The anode current collector layer 22 may include a substrate layer 221 and a porous plating layer 222 positioned on the substrate layer 221.

The thickness of the anode current collector layer 22 may be about 5 μm to 50 μm, or about 15 μm to 20 μm. Considering that the conventional copper foam has a thickness of 100 μm or greater, the anode current collector layer 22 may be in a thin-filmed form. Therefore, the cathode current collector layer (22), according to an exemplary embodiment of the present invention, may be used to increase the energy density of the lithium secondary battery.

The anode current collector layer 22 may include copper, nickel, or combinations thereof. Particularly, the anode current collector layer 22 may include copper. The substrate layer 221 and the plating layer 222 may have the same or different materials. However, in consideration of the bonding force and compatibility between the two components, the substrate layer 221 and the plating layer 222 may be preferably made of the same material.

The substrate layer 221 may provide a space for the plating layer 222 to be formed and may be a plate-shaped substrate.

The plating layer 222 m a porous layer and provides a space in which lithium can be deposited when charging a lithium secondary battery.

The plating layer 222 may include a first pore (A) formed to be recessed into a predetermined depth from a surface thereof and a second pore (B) formed therein. For example, the first pores (A) may mean open pores, and the second pores (B) may mean closed pores. The first pores (A) are formed by the movement of hydrogen gas generated in the process of forming the plating layer 222, which will be described later.

As shown in FIG. 2, the diameter (D) of the first pores (A) may be about 10 μm to 60 μm, or about 20 μm to 40 μm. The diameter of the first pores (A) may refer to a diameter of an opening through which the first pores (A) communicate with the outside based on the surface of the plating layer 222.

Since the plating layer 222, according to the present invention, is a porous layer including the first pores (A) and the second pores (B), lithium dendrite may be generated during charging and discharging of the lithium secondary battery may be effectively suppressed.

The anode current collector layer 22 may further include a coating layer 223 formed to a thickness of nanometers on the plating layer 222 without damaging its shape. That the coating layer 223 does not damage the shape of the plating layer 222 means that the coating layer 223 is formed according to the shape of the plating layer 222 without blocking the first pores (A) and the second pores (B).

The coating layer 223 is configured to improve the wettability of the anode current collector layer 22 to lithium metal. When lithium metal is deposited on the anode current collector layer 22, more precisely, the plating layer 222, the contact angle becomes small when lithium metal comes into contact with the coating layer 223 and spreads widely along the surface so that the aggregation of lithium metal can be suppressed. As a result, the growth of lithium dendrites can be suppressed.

The coating layer 223 may include a material having a negative Gibbs free energy change when reacting with lithium at a melting point or higher of lithium. For example, the coating layer 223 may include at least one selected from the group consisting of silver, gold, magnesium, silicon, zinc, germanium, tin, aluminum oxide, copper oxide, zinc oxide, and combinations thereof.

The lithium metal layer 21 is interposed between the separator 30 and the anode current collector layer 22, but may exist in a state in which a portion thereof has penetrated into the porous plating layer 222. Specifically, the lithium metal layer 21 may be in a state in which the lithium metal layer 21 is permeated into the first pores A and/or the second pores B of the plating layer 222.

The combined thickness of the lithium metal layer 21 and the plating layer 222 may vary depending on the degree of permeate of the lithium metal layer 21 but may be 15 μm to 30 μm.

The separator 30 may be used alone or by laminating a porous polymer film generally used in the technical field of the present invention, for example, a porous polymer film made of ethylene homopolymer, propylene homopolymer, ethylene/butene copolymer, ethylene/hexene copolymer, and ethylene/methacrylate copolymer. On the other hand, as the separator 30, a conventional porous non-woven fabric, for example, a non-woven fabric made of high melting point glass fiber, polyethylene terephthalate fiber, or the like, may be used, but the present invention is not limited thereto.

The separator 30 may be impregnated with an electrolyte (not shown). The electrolyte may include an electrolyte and a lithium salt.

The electrolyte is a kind of organic solvent and is not limited as long as the electrolyte can be used in a lithium secondary battery. The electrolyte may include, for example, ethylene carbonate, dimethyl carbonate, diethyl carbonate, ethylmethyl carbonate, fluoroethylene carbonate, 1,2-dimethoxyethane, 1,2-diethoxyethane, dimethylene glycol dimethyl ether, trimethylene glycol dimethyl ether, triethylene glycol dimethyl ether, tetraethylene glycol dimethyl ether, polyethylene glycol dimethyl ether, succinonitrile, sulfolane, dimethyl sulfone, ethyl methyl sulfone, diethyl sulfone, adiponitrile, 1,1,2,2-tetrafluoroethyl 2,2,3,3-tetrafluoropropyl ether, dimethylacetamide, and the like.

The lithium salt is not limited as long as it can be used in a lithium secondary battery and may include, for example, LiNO₃, LiPF₆, LiBF₆, LiClO₄, LiCF₃SO₃, LiBr, LII, and the like.

The method for manufacturing an anode may include forming a porous plating layer 222 on a substrate layer 221, forming a coating layer 223 on the plating layer 222 to prepare an anode current collector layer 22, and forming a lithium metal layer 21 on the anode current collector layer 22.

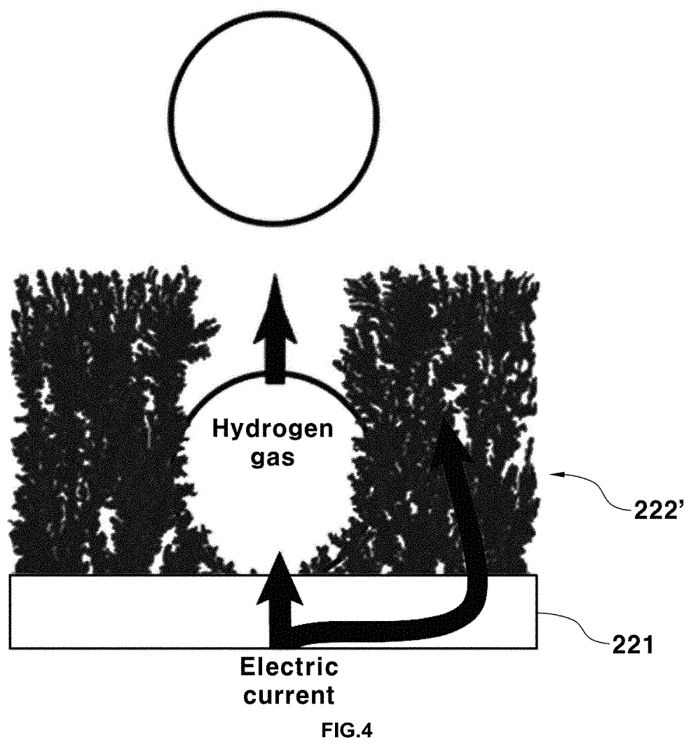

FIG. 3 shows a result of forming the plating layer 222. Referring to FIG. 3, forming the plating layer 222 may include immersing the substrate layer 221 in a plating solution containing a copper ion source and sulfuric acid and applying an electric current to the substrate layer 221 to form a porous plating layer 222′ containing copper on the substrate layer 221.

In the present invention, since the porous plating layer 222 is formed using electroplating, the thickness thereof can be formed to be very thin as described above. In addition, due to the characteristics of plating, it is advantageous to manufacture in a large area, and the processing time is very short compared to other methods such as roll pressing.

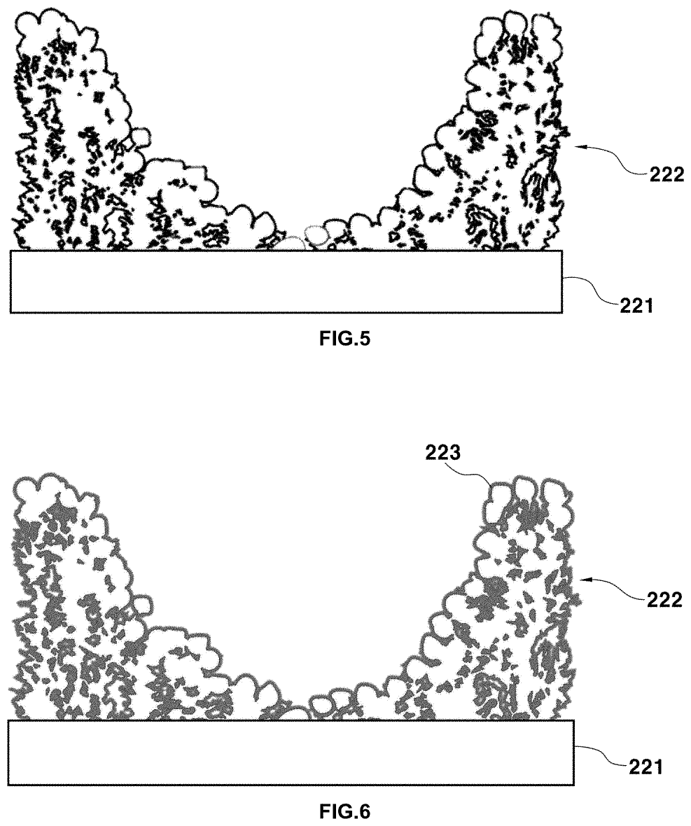

FIG. 4 is a reference diagram for explaining a process in which pores are formed in the plating layer 222′.

When an electric current is applied to the substrate layer 221, a plating layer 222′ due to a copper ion source is formed on the surface thereof, and in the process, hydrogen gas is also generated from sulfuric acid, an aqueous solvent, and the like included in the plating solution near the surface of the substrate layer 221 through which the current flows. Since the formation of the plating layer 222′ at the generation part of the hydrogen gas is suppressed compared to other parts, first pores A are formed.

On the other hand, as the plating layer 222′ is gradually formed, an electric current flows through the substrate layer 221 to the plating layer 222′ as well, and thus hydrogen gas is also generated inside the plating layer 222′. Accordingly, the second pores B are formed in the plating layer 222′.

Conditions for applying a current to the substrate layer 221 may be appropriately adjusted according to the desired thickness and pore size of the plating layer 222′. For example, the plating layer 222′ may be formed by applying a current having a current density of 0.1 mA/cm² to 1 mA/cm² to the substrate layer 221 for 10 to 60 seconds.

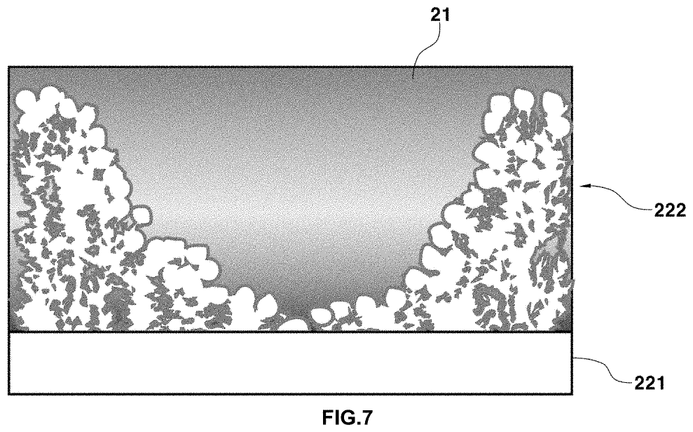

The result of FIG. 3 may be used as it is, but the plating layer 222′ may be reinforced through post-plating to withstand the pressure applied during bonding with other components such as a separator and a cathode. Specifically, the manufacturing method may further include immersing the base layer 221 on which the plating layer 222′ is formed in a plating solution containing a copper ion source and sulfuric acid and applying an electric current to perform a post-plating treatment. Accordingly, the plating layer 222 in which the microstructure is reinforced may be obtained. FIG. 5 shows the plating layer 222 after the post-plating has been completed.

Conditions for applying a current during the post-plating process may be appropriately adjusted according to the desired strength, shape, and the like of the plating layer 222. The plating layer 222 may be formed by applying a current having a current density of 10 mA/cm² to 100 mA/cm² to the substrate layer 221 for 10 to 60 minutes.

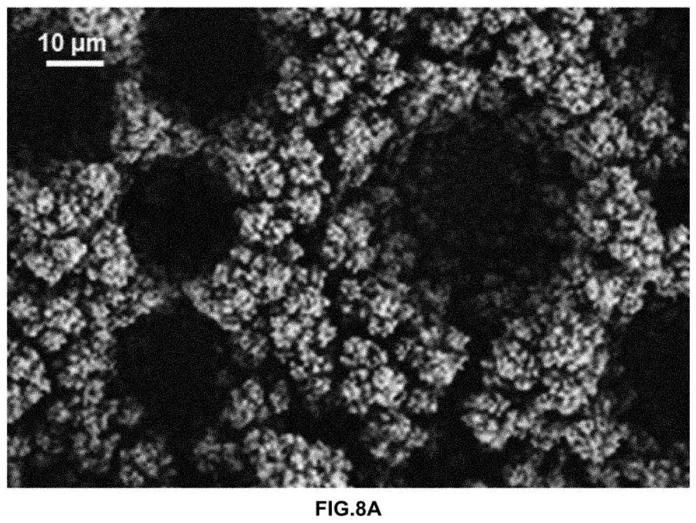

Thereafter, a coating layer 223 may be formed on the plating layer 222. FIG. 6 shows a result of forming the coating layer 223.

The coating layer 223 may be formed by sputtering a metal such as silver on the plating layer 222. Conditions for sputtering may be appropriately adjusted in consideration of the desired thickness of the coating layer 223. For example, sputtering can be performed in 3000 seconds or less under the conditions of DC 100 W and Ar 10 mTorr.

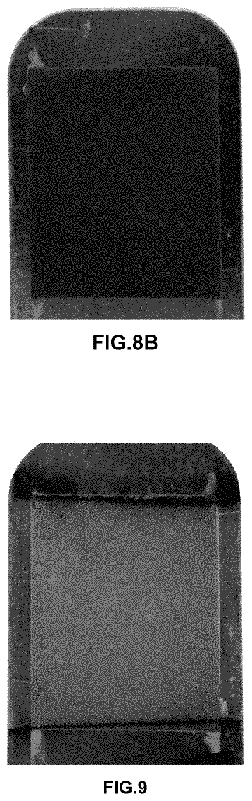

A lithium metal layer 21 may be formed on the anode current collector layer 22 prepared as above. FIG. 7 shows the result of forming the lithium metal layer 21.

The method of forming the lithium metal layer is not particularly limited but may be formed by permeating molten lithium on the plating layer 22 so that a portion thereof can penetrate into the porous plating layer 222.

### EXAMPLE

Hereinafter, the present invention will be described in detail with reference to the following Examples and Comparative Examples. However, the technical spirit of the present invention is not limited or limited thereto.

### EXAMPLE

Sulfuric acid (H₂SO₄) and copper sulfate (CuSO₄) were added to distilled water at concentrations of 0.5 M and 0.1 M, respectively, and stirred at room temperature to prepare a plating solution.

A copper plate was prepared as a substrate layer. The substrate layer was introduced as a working electrode, and another copper plate was prepared as a counter electrode, and these two electrodes were immersed in the plating solution.

An elect is current having a current density of 0.4 mA/cm² was applied to the substrate layer for about 25 seconds to form a plating layer.

After plating was completed, the plating layer was washed with distilled water and ethanol in that order and dried in a vacuum oven.

Sulfuric acid (H₂SO₄) and copper sulfate (CuSO₄) were added to distilled water at concentrations of 0.4 M and 0.8 M, respectively, and stirred at room temperature to prepare a plating solution for post-plating.

The substrate layer on which the plating layer was formed was introduced as a working electrode, and another copper plate was prepared as a counter electrode, and these two electrodes were immersed in the plating solution.

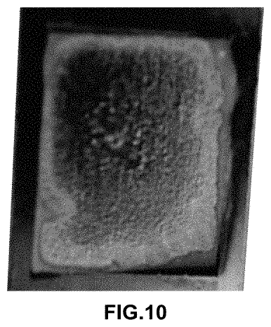

The microstructure of the plating layer was reinforced by applying an electric current to the substrate layer on which the plating layer was formed under a predetermined condition. FIG. 8A shows a result of analyzing the surface of the plating layer with an electron microscope. FIG. 8B shows a result of visually observing the surface of the plating layer. As shown in FIGS. 8A and 8B, the first pores and the second pores are well-formed in the plating layer.

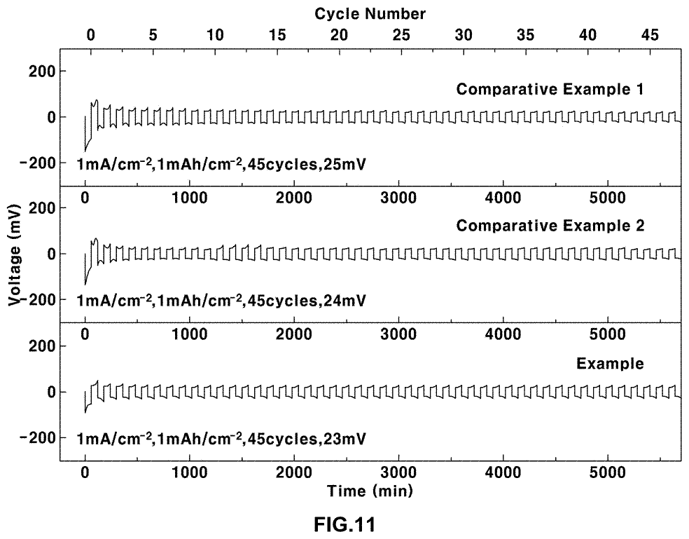

An anode current collector layer, according to an exemplary embodiment of the present invention, was prepared by sputtering silver on the plating layer to form a coating layer. Sputtering was performed for about 2,000 seconds under the conditions of DC 100 W and Ar 10 mTorr. FIG. 9 shows a result of visually observing the surface of the anode current collector layer.

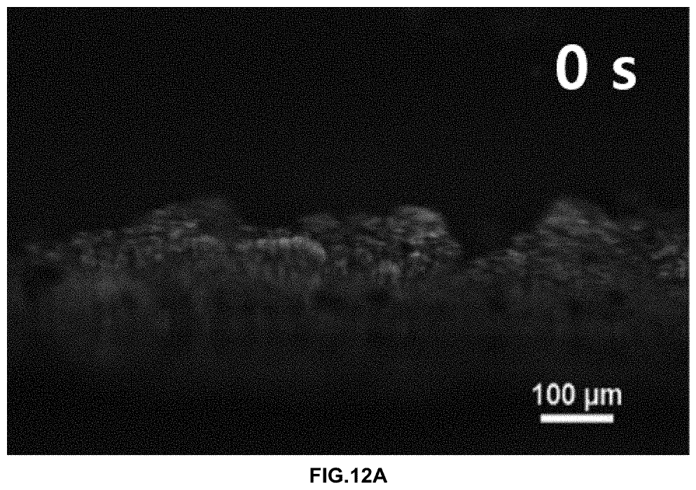

The lithium metal was placed on a stainless steel plate coated with titanium and heated to a temperature of about 275° C. on a hot plate to obtain molten lithium metal. At the same time, the anode current collector layer was also heated at the same temperature. An anode, according to the present invention, was prepared by transferring molten lithium to the anode current collector layer in the form of beads having a diameter of 3 mm or less (<7.6 mg) and allowing to permeate through. FIG. 10 shows a result of visually observing the surface of the anode.

Asymmetrical cell using the anode was prepared. Particularly, the anode was punched to have a diameter of 12 mm and attached to both sides of a separator having a thickness of about 16 mm. Asymmetrical cell was prepared by injecting 100 μl of an electrolyte in which 1.0 M LITFSIDOL and DME were mixed in a volume ratio of 1:1 into the separation membrane.

### Comparative Example 1

The asymmetrical cell was prepared in the same manner as in Example, except that lithium foil having the same thickness as the anode of the above embodiment was used as the anode.

### Comparative Example 2

The asymmetrical cell was prepared in the same manner as in Example except that the lithium foil of Comparative Example 1 was attached on a flat copper thin film and used as the anode.

### Experimental Example 1—Charging/Discharging Safety Test

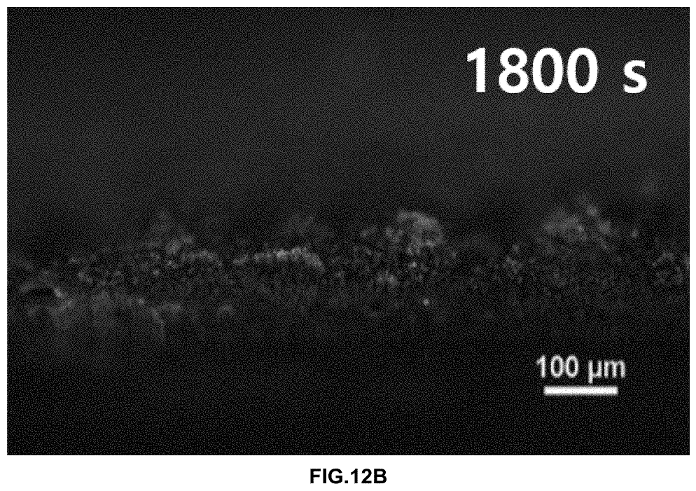

The asymmetrical cells, according to Example, Comparative Examples 1 and 2 were charged and discharged 45 times with an area capacity of 1 mAh/cm² at a current density of 1 mA/cm², and their behavior was observed. The results are shown in FIG. 11. As shown in FIG. 11, the symmetric cell of Example showed a similar level of overpotential to the symmetric cells of Comparative Examples 1 and 2, and showed stable results.

### Experimental Example 2—Evaluation of Lithium Dendrite Inhibitory Effect

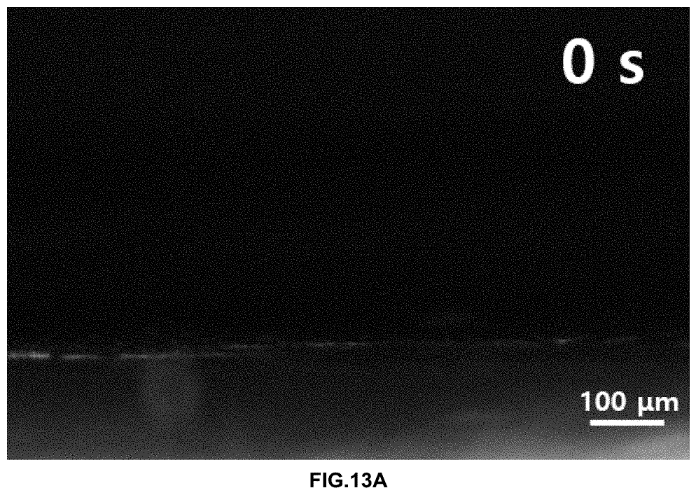

(Example) The anode current collector using self-manufactured equipment prepared in the above example was placed on one side, lithium metal was mounted at a certain distance from the anode, and a liquid electrolyte was filled therebetween. The lithium metal was electrodeposited on the anode current collector with an area capacity of 0.5 mAh/cm² at a current density of 1 mA/cm². FIG. 12A shows a result of microscopic analysis of the surface of the anode current collector before electrodeposition. FIG. 12B shows a result of microscopic analysis of the surface of the anode current collector after electrodeposition.

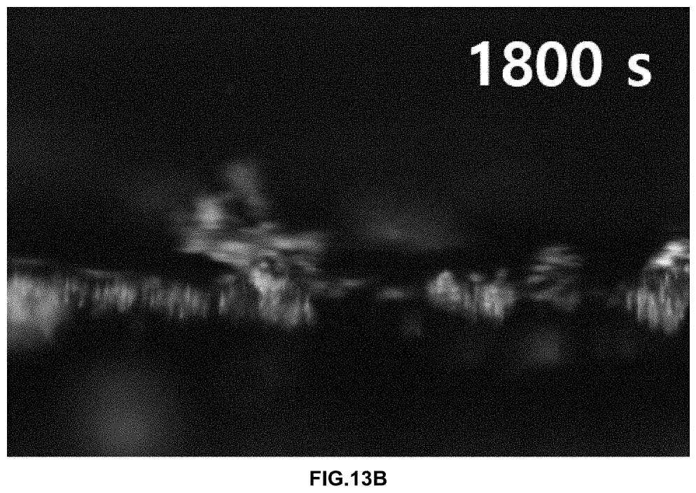

(Comparative Example 2) Lithium metal was charged to the copper thin film in the same manner except that the flat copper thin film used in Comparative Example 2 was mounted instead of the anode current collector. FIG. 13A shows a result of microscopic analysis of the surface of the copper thin film before electrodeposition. FIG. 13B shows a result of microscopic analysis of the surface of the copper thin film after electrodeposition.

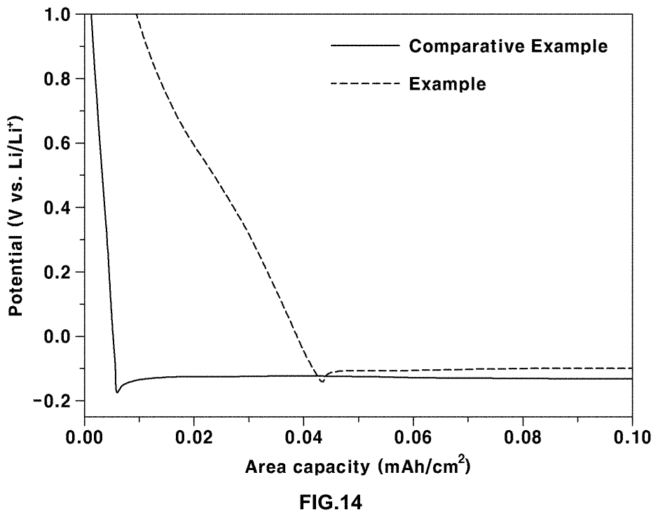

FIG. 14 is a graph of a voltage applied during lithium electrodeposition in Example and Comparative Example 2. As shown in FIG. 14 when the anode current collector of the Example is used, the overvoltage is low, and the lithium metal is electrodeposited more stably.

As described above, although the embodiments have been described with reference to the exemplary embodiments and drawings, various modifications and variations are possible from the above description by those skilled in the art. For example, even if the described techniques are performed in a different order from the described method, and/or the described elements are combined or combined in a different form from the described method, or are substituted or substituted by another component or equivalent, appropriate results may be achieved. Therefore, other implementations, other embodiments, and equivalents to the claims are also within the scope of the following claims.

What is claimed is:

1. An anode for a lithium secondary battery, comprising:
an anode current collector layer comprising a substrate layer and a porous plating layer disposed on the substrate layer; and
a lithium metal layer disposed on the plating layer,
wherein the anode current collector layer has a thickness of about 5 μm to 50 μm.

2. The anode of claim 1, wherein the anode current collector layer comprises copper, nickel, or combinations thereof.

3. The anode of claim 1, wherein the porous plating layer comprises first pores having a predetermined depth from the surface of the plating layer and second pores formed in the first pores.

4. The anode of claim 3, wherein the first pores has a diameter of about 10 μm to 60 μm.

5. The anode of claim 1, further comprising a coating layer having a thickness of about 10 nm to 100 nm on the porous plating layer.

6. The anode of claim 5, wherein the coating layer comprises one or more selected from the group consisting of silver, gold, magnesium, silicon, zinc, germanium, tin, aluminum oxide, copper oxide, and zinc oxide.

7. The anode of claim 1, wherein the lithium metal layer partially penetrates into the porous plating layer.

8. A lithium secondary battery comprising:
a cathode;
the anode of claim 1;
a separator interposed between the cathode and the anode; and
an electrolyte impregnated in the separator.

9. A method of manufacturing an anode for a lithium secondary battery, comprising:
forming a porous plating layer on a substrate layer;
forming a coating layer on the porous plating layer to prepare an anode current collector layer; and
forming a lithium metal layer on the anode current collector layer,
wherein the anode current collector layer has a thickness of about 5 μm to 50 μm.

10. The method of claim 9, wherein the forming of the plating layer comprises:
immersing the substrate layer in a plating solution comprising a copper ion source and sulfuric acid; and
forming the porous plating layer comprising copper on the substrate layer by applying an electric current to the substrate layer.

11. The method of claim 10, wherein the plating layer is formed by applying an electric current having a current density of about 0.1 mA/cm² to 1 mA/cm² to the substrate layer for about 10 seconds to 60 seconds.

12. The method of claim 10, wherein first pores are formed to be recessed to a predetermined depth from the surface of the plating layer by hydrogen gas generated when the electric current is applied to the substrate layer, and second pores located therein are formed in the first pores.

13. The method of claim 12, wherein the first pores have a diameter of about 10 μm to 60 μm.

14. The method of claim 9, after forming the porous plating layer on the substrate, further comprising:
immersing the substrate layer on which the porous plating layer is formed in a plating solution comprising a copper ion source and sulfuric acid; and
applying an electric current performing post-plating treatment.

15. The method of claim 9, wherein the coating layer is formed by sputtering one or more metal selected from the group consisting of silver, gold, magnesium, silicon, zinc, germanium, tin, aluminum oxide, copper oxide, and zinc oxide on the porous plating layer.

16. The method of claim 9, wherein the coating layer has a thickness of about 10 nm to 100 nm.

17. The method of claim 9, wherein the lithium metal layer is formed by causing molten lithium to permeate into the plating layer.

18. The method of claim 9, wherein the lithium metal layer partially penetrates into the porous plating layer.
